(19) United States
(12) Patent Application Publication
(10) Pub. No.: US 2025/0013405 A1
(43) Pub. Date: Jan. 9, 2025

(54) NON-TRANSITORY COMPUTER-READABLE RECORDING MEDIUM CONTAINING COMPUTER-EXECUTABLE INSTRUCTIONS WHICH CAUSES INFORMATION PROCESSING DEVICE TO SUPPORT PRINTING BY PRINTING DEVICE CONNECTED THERETO

(71) Applicant: BROTHER KOGYO KABUSHIKI KAISHA, Nagoya (JP)

(72) Inventors: Yoshito HOSOMIZO, Konan (JP); Kenju NARITA, Nagoya (JP)

(21) Appl. No.: 18/888,265

(22) Filed: Sep. 18, 2024

Related U.S. Application Data
(63) Continuation of application No. PCT/JP2023/009283, filed on Mar. 10, 2023.

(30) Foreign Application Priority Data
Mar. 28, 2022 (JP) 2022-051673

(51) Int. Cl. G06F 3/12

(52) U.S. Cl. CPC G06F 3/1248; G06F 3/1205; G06F 3/1238

(57) ABSTRACT

A support program of an information processing device registers a particular file format that does not generate intermediate data in a general-purpose print program incorporated in an OS of the information processing device. In a case where a process is required from the general-purpose print program in response to a print instruction which instructs the general-use print program to cause the virtual printing device to print an image and is output by an application program of the information processing device, the support program generates print data based on the intermediate data and transmits a print job including the print data to the virtual printing device when the intermediate data is passed from the general-purpose print program. When image data in the particular file format is passed from the general-purpose print program, the support program transmits a print job including the image data to the virtual printing device.

### REFERENCE TO RELATED APPLICATIONS

This application is a continuation of PCT International Application No. PCT/JP2023/009283 filed on Mar. 10, 2023, and claims priority from Japanese Patent Application No. 2022-051673 filed on Mar. 28, 2022, which are incorporated herein by reference in their entirety.

### BACKGROUND ART

The present disclosure relates to a non-transitory computer-readable storage medium, and a method for supporting in controlling a printing device.

In recent years, a technology has been put to practical use in which a printer is controlled by a general-purpose print program that is incorporated as standard into an operating system (hereinafter referred to as the “OS”) of an information processing device, without using a printer driver. In this technology, the OS associates the printer with the OS-standard general-purpose print program in response to detecting the printer, and thereafter, the information processing device is enabled to cause the printer to perform printing with the OS-standard general-purpose print program without using a printer driver in response to receiving a print instruction to the printer.

Further, there is known a technology to associate a support program with the OS-standard general-purpose print program and realize printing by linking the general-purpose print program and the support program. For example, according to one of such conventional configurations, a general-purpose print program generates intermediate data in an XPS format based on image data to be printed, a support program generates print data in a PDL format based on that intermediate data, and that print data is transmitted to a printer by the general-purpose print program. According to another of the conventional configurations, after the support program edits the intermediate data, the general-purpose print program generates print data in an RWGraster format or the PDF (Portable Document Format) based on the edited intermediate data, and the print data is transmitted to the printer.

### SUMMARY

A technology is known for a so-called “cloud print system” in which a cloud server on the Internet is used as a virtual printer, a print job is submitted to the virtual printer from an OS-standard general-purpose print program, and a printer connected to the cloud server receives the print job and executes the print job. In such a “cloud print system,” if, for example, the printer is a model that can handle the PDF data, then it is sufficient to submit the PDF data to the cloud server. However, in printing via a general-purpose print program, as mentioned above, intermediate data is generated based on the image data to be printed, and then, the print data is generated based on the intermediate data. Therefore, if the image data to be printed is the PDF data, the process is redundant because the file format conversion from the PDF data to the intermediate data, and then to the print data is performed, even though the printer can handle the image data. Further, image quality may be degraded when file formats are converted, and less opportunity for file format conversion is desirable.

According to aspects of the present disclosures, there is provided a non-transitory computer-readable recording medium containing computer-executable instructions that are executable by a computer of an information processing device and compatible with a printing device connected with the information processing device. The computer-executable instructions realizes a support program supporting a general-purpose print program incorporated in advance in an operating system of the information processing device. The information processing device is configured to connect to a virtual printing device provided to a server on a network. The server is configured to receive a print job transmitted to the virtual printing device and store the received print job. The server is configured to transmit the stored print job to a printing device based on a request from the printing device connected to the server, the support program being configured to, when executed by the computer, cause the information processing device to perform registering a particular file format as a file format that does not generate intermediate data in the general-purpose print program in a case where a print job is to be transmitted to the virtual printing device. In a case where execution of a process is required from the general-purpose print program in response to a print instruction which instructs the general-use print program to cause the virtual printing device to print an image and is output by an application program implemented in the information processing device, the support program is configured to, when executed by the computer, cause the information processing device to perform, when the intermediate data is passed from the general-purpose print program, generating print data based on the passed intermediate data and transmitting a print job including the generated print data to the virtual printing device, and, when image data in the particular file format is passed from the general-purpose print program, transmitting a print job including the passed image data to the virtual printing device.

### BRIEF DESCRIPTION OF DRAWINGS

FIG. 1 schematically shows a configuration of a print system.

FIG. 2 is a sequence chart showing an example of a procedure when “Print” is selected.

FIG. 3 is a sequence chart showing an example of a procedure when a print instruction is received.

FIG. 4 is a flowchart illustrating a setting process.

FIG. 5 is a sequence chart showing an example of a procedure when “Print” is selected.

FIG. 6 is a sequence chart showing another example of a procedure when “Print” is selected.

FIG. 7 is a sequence chart showing an example of a procedure when a print instruction is received.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

A detailed explanation will be provided below of a personal computer (hereinafter referred to as the “PC”) using a support program in illustrative embodiments according to aspects of the present disclosure, with reference to the accompanying drawings. In the present disclosure, a print system configured such that an OS-standard general-purpose print program causes a printer to perform printing via a cloud print system is described.

### First Embodiment

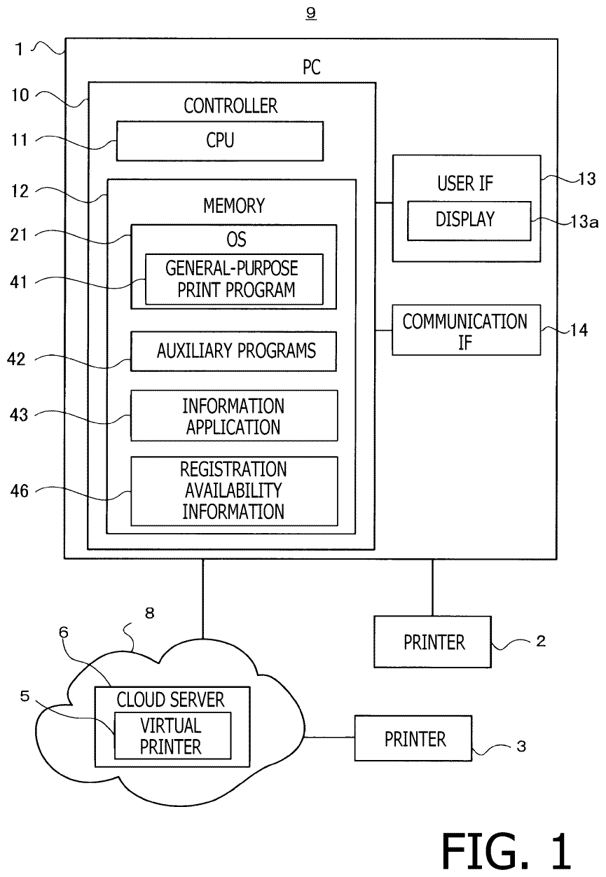

FIG. 1 schematically shows a configuration of a print system 9. The print system 9 includes a PC 1, a printer 2 and a printer 3. The printer 2 may be connected to the Internet, or directly connected to the PC 1. Each of the PC 1 and the printer 3 is configured to mutually communicate with a cloud server 6 provided on the Internet 8. The cloud server 6 is provided with a virtual printer 5. The printer 2 and the printer 3 are real physical printers, whereas the virtual printer 5 is a logical printer that is virtually treated as a single printer. For the sake of description, the real physical printers may also be referred to as “real printers” below. The printer 2 and the printer 3 may be examples of a “printing device” according to aspects of the present disclosure. The virtual printer 5 may be an example of a “virtual printing device” according to aspects of the present disclosure.

The print system 9 is a system that uses cloud services provided, for example, by Microsoft Corporation, to achieve universal printing, where printing is performed via the virtual printer 5. In other words, the cloud server 6 can be provided by a company other than a printer manufacturer. The Internet 8 may be an example of a network according to aspects of the present disclosure. The cloud server 6 may be an example of a server according to aspects of the present disclosure. In the present embodiment, it is assumed that the real printer that can handle PDF image data is connected to the virtual printer 5 of the cloud server 6.

As shown in FIG. 1, the PC 1 of the present embodiment has a controller 10 that includes a CPU 11 and a memory 12. The PC 1 may be an example of an “information processing device” according to aspects of the present disclosure. The CPU 11 may be an example of a “computer” according to aspects of the present disclosure. The PC 1 further includes a user interface (hereinafter referred to as the “user I/F”) 13 and a communication interface (hereinafter referred to as the “communication I/F”) 14, which are electrically connected with the controller 10. The “controller 10” in FIG. 1 is a collective term for hardware and software used to control the PC 1 and may not necessarily represent a single hardware element actually existing in the PC 1.

The CPU 11 is configured to perform various processes according to programs read from the memory 12 and based on user operations. The memory 12 stores various types of data and various programs. The memory 12 is also used as a work area when various processes are performed. A buffer provided to the CPU 11 may be an example of a “memory” according to aspects of the present disclosure. Examples of the memory 12 are not limited to a ROM, a RAM, and an HDD that are incorporated in the PC 1, but may include storage media (e.g., CD-ROMs and DVD-ROMs) that are readable and writable by the CPU 11.

The user I/F 13 includes hardware configured to display screens to provide information to the user, and hardware configured to receive user operations. The user I/F 13 may have a combination of a display 13a configured to display information, and a mouse and/or a keyboard that are configured to accept user input operations, i.e., having an input acceptance function. The user I/F 13 may include a touch panel having the display 13a and the input acceptance function.

The communication I/F 14 includes hardware configured to communicate with external devices such as the printer 2. Communication standards applicable for the communication I/F 14 include Ethernet (“Ethernet” is a registered trademark of Fuji Xerox Co., Ltd.), Wi-Fi (“Wi-Fi” is a registered trademark of the non-profit Wi-Fi Alliance), and USB. The PC 1 may be configured to connect with the Internet via the communication I/F 14. The PC 1 may have a plurality of communication I/Fs 14 conforming to a plurality of communication standards.

As shown in FIG. 1, the memory 12 of the PC 1 stores an operating system (hereinafter referred to as the “OS”) 21 including a general-purpose print program 41, and further stores auxiliary programs 42 and various application programs (hereinafter, which may be referred to as the “applications”). Examples of the OS 21 may include, but are not limited to, Windows (“Windows” is a registered trademark of Microsoft Corporation), macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC). The auxiliary programs 42 are examples of a support program according to aspects of the present disclosure.

The PC 1 in the present embodiment incorporates various applications such as an information application 43. The information application 43 is, for instance, a map application, a calendar application, or a browser. The information application 43 is configured to, when executed by the CPU 11, cause the PC 1 to display various types of information on the display 13a in response to user requests. The information application 43 may be an example of an “application program” according to aspects of the present disclosure. The information application 43 itself may not necessarily have a function to print the displayed information.

The general-purpose print program 41 is an OS-standard program provided with the OS 21 and has a function to cause the printer 2 to print information that is displayed on the display 13a by the information application 43. The general-purpose print program 41 in the present embodiment is a program having a function for generating the intermediate data based on the image data to be printed. The general-purpose print program 41 supports functions that are usable in common by a plurality of printer models provided by vendor(s) of various printers. Unlike printer drivers that are specific to individual printers, the general-purpose print program 41 does not support all of the functions that are unique to the individual printers. Functions supportable by the general-purpose print program 41 are limited to generic functions.

The auxiliary programs 42 include one program or a group of programs configured to, when executed by the CPU 11, cause the PC 1 to perform processing based on instructions from the OS 21, accompanying processing by the general-purpose print program 41. The auxiliary programs 42 include one or more programs that support control of target hardware elements. The auxiliary programs 42 in the present embodiment are compatible with a model of the printer 2 connected with the PC 1. The auxiliary programs 42 are launched from the general-purpose print program 41, for instance, when the PC 1 has received an instruction to cause the printer 2 to perform printing using the general-purpose print program 41. The auxiliary programs 42 are called, for instance, PSA (“PSA” is an abbreviation for “Print Support Application”) or HSA (“HAS” is an abbreviation for “Hardware Support Application”).

For instance, the auxiliary programs 42 may include a combination of a plurality of programs each of which is configured to, when executed by the CPU 11, cause the PC 1 to accept execution instructions. In another instance, the auxiliary programs 42 may include one program configured to, when executed by the CPU 11, cause the PC 1 to accept instructions and perform respective different processes according to the accepted instructions. The auxiliary programs 42 may include a program prepared for each type of printer by the printer vendor(s). For instance, the auxiliary programs 42 may include an auxiliary program prepared for inkjet printers and an auxiliary program prepared for laser printers. The auxiliary programs 42 may include not only the auxiliary program prepared for each type of printer but also an auxiliary program prepared for each model of printer or an auxiliary program prepared for each series of models of printers.

The PC 1 is connected to the cloud server 6 via the Internet 8 as shown in FIG. 1. The cloud server 6 is an information processing device having a communication function. The virtual printer 5 of the cloud server 6 is configured to receive print jobs from the PC 1 as an individual printer and stored the received print jobs. When the virtual printer 5 receives a transmission request for a print job from a real printer, the virtual printer 5 is configured to transmit the print job to the real printer.

When the real printer is connected, the OS 21 registers printer information, which is information about the connected real printer. For example, when a new virtual printer is connected to the PC 1, the OS 21 registers the connected virtual printer as one of the printers that connectable to the PC 1, in the same way as a real printer.

Each of the printer 2 and the printer 3 is the real printer that has at least printing and communication functions. Each of the printer 2 and the printer 3 is configured to receive print data and print settings from an external device, and perform printing in accordance with the print settings. The printer 2 is not connected to the cloud server 6, while the printer 3 is communicatively connected to the cloud server 6. When connected to the cloud server 6, the printer 3 receives, for example, a print job that had been transmitted to the virtual printer 5, from the virtual printer 5 and performs the print job.

The auxiliary programs 42 are registered with the general-purpose print program 41 or the OS 21 as programs to be started based on the selection of the printer 2 at the time of installation. Further, the auxiliary programs 42 are also registered with the general-purpose print program 41 or the OS 21 as programs to be started based on the selection of the virtual printer 5.

The auxiliary programs 42 according to the present embodiment are configured such that whether or not to perform a pass-through registration is set. The pass-through registration is a process of registering a particular file format to the general-purpose print program 41 as a file format that does not generate intermediate data. The particular file format is, for example, the PDF. In the present embodiment, registration availability information 46 indicating whether or not to perform the pass-through registration is stored in the memory 12. The registration availability information 46 is set to ON when the pass-through registration is to be performed, and is set to OFF when the pass-through registration is not to be performed, in the setting process described below.

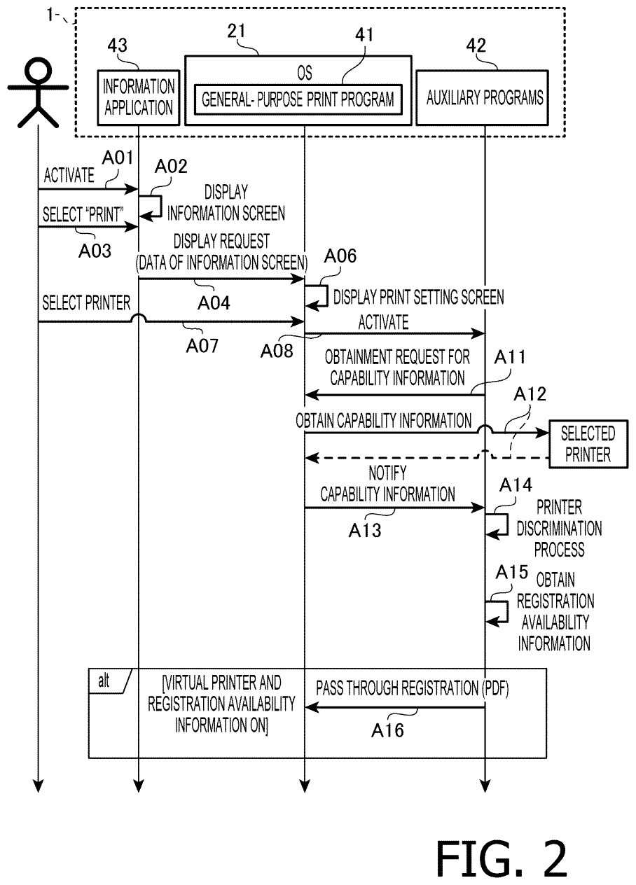

Next, an explanation will be provided of a procedure of printing that includes operations of the auxiliary programs 42 in the present embodiment, i.e., a procedure of operations by the individual programs when printing is selected via the information application 43, with reference to a sequence chart in FIG. 2. In FIG. 2 and after-mentioned other sequence charts, operations when the auxiliary programs 42 compatible with the printer 2 are incorporated in the PC 1 are shown.

Each processing step in the processes and flowcharts, sequence, diagrama in the present embodiment basically indicates processing by the CPU 11 according to the instructions described in the auxiliary programs 42 and other programs. The processing by the CPU 11 includes hardware control using an API (“API” is an abbreviation for “Application Programming Interface”) of the OS 21. In the present disclosure, the operations by the individual programs may be described without a detailed explanation of the OS 21. In addition, “obtaining” and “acquiring” may be used as concepts that do not necessarily require a request.

At the beginning of the procedure, a user activates the information application 43 (A01). The information application 43 displays an information screen containing various types of information on the display 13a in response to a user's instruction (A02). If the user wishes to print an image of the information screen being displayed, the user selects “Print” on the information screen (A03). The information application 43 then transmits a display request along with data of the information screen to the general-purpose print program 41 in the OS 21 (A04).

The general-purpose print program 41 displays a print setting screen on the display 13a in response to the display request (A06). The print setting screen is configured to accept instructions for print settings and a print execution instruction.

The user is allowed to select a printer by performing an operation on the general-purpose print setting screen being displayed (A07). When the printer 2 is selected, the general-purpose print program 41 activates the auxiliary programs 42 compatible with the printer 2 and sends to the auxiliary programs 42 a processing request for processing according to the selection of the printer 2 (A08). In A08, the general-purpose print program 41 passes information on the selected printer 2 and information on the print settings as set at the time of printer selection to the auxiliary programs 42.

When the printer 2 is set as a normally-used printer in the OS 21, the general-purpose print program 41 displays the general-purpose print setting screen with the printer 2 selected (A06) and activates the auxiliary programs 42 (A08). Namely, the printer 2 is automatically selected by the OS 21, and the general-purpose print program 41 executes A08 based on the information on the selected printer 2. In this case, the user operation in A07 is unnecessary. When the virtual printer 5 is set as a normally-used printer, the similar processes are executed.

Instead of the general-purpose print program 41 displaying the general-purpose print setting screen, the information application 43 may be configured to display the general-purpose print setting screen. In such a case, the information application 43 may activate the general-purpose print program 41 in response to “Print” being selected in A03, obtain data to be displayed on the general-purpose print setting screen from the general-purpose print program 41, and display the general-purpose print setting screen on the display 13a. Then, the information application 43 may pass the information on the selected printer to the general-purpose print program 41 in response to the printer 2 or the virtual printer 5 having already been selected, or in response to the printer 2 or the virtual printer 5 being selected in A07. Thereby, the general-purpose print program 41 activates the auxiliary programs 42 in A08.

The auxiliary programs 42, in response to being activated, determine whether the capability dependent information 44 corresponding to the selected printer has already been stored in the memory 12 (A09). For example, when the printer 2 is selected in A07, upon receiving a request from the auxiliary programs 42, the OS 21 transmits an obtaining request to the printer 2 to obtain capability information, and obtains the capability information from the printer 2 (A12). The OS 21 passes the capability information obtained from the printer 2 to the auxiliary programs 42 (A13).

For instance, the OS 21 performs communication according to IPP (“IPP” is an abbreviation for “Internet Printing Protocol”) with the printer 2. Instead of sending the request to the OS 21, for instance, the auxiliary programs 42 may directly obtain the capability information from the printer 2 using MIB (“MIB” is an abbreviation for “Management Information Base”).

The capability information obtained from the printer 2, which is a real printer, includes information on parameters that are settable as print settings. The capability information further includes, for instance, status information, information on remaining amounts of consumables, information on attached trays, sheet information on sheets set for each tray, and information on supported print resolutions. The printer 2 may have functions to perform image processing based on a received print job and perform printing based on data obtained after the image processing, e.g., functions to perform layout printing such as N in 1, composition printing such as printing an image combined with a watermark, and saving printing to save colorant. When the printer 2 has image processing functions executable thereon, the printer 2 may pass information on the image processing functions to the OS 21 as capability information. The capability information obtained from the printer 2 may include information indicating post processes such as stapling of fastening print sheets with a needle.

The capability information obtained from the printer 2 may include information on functions that are not processed by the printer 2 but are processed by the auxiliary programs 42. Examples of functions that are not processed by the printer 2 but are processed by the auxiliary programs 42 include booklet printing and poster printing.

Further, the capability information obtained from the printer 2 includes identification information to identify the printer. An example of the identification information includes device identifying information to identify the device. Examples of device identifying information include printer-specific hardware keys and particular information that would be held by a printer manufactured by a particular printer manufacturer.

The capability information obtained from the virtual printer 5 also contains identification information. However, the identification information obtained from the virtual printer 5 does not include device identifying information. The identification information obtained from the virtual printer 5 may include identifying information specific for the virtual printer 5. Further, the capability information from the virtual printer 5 may or may not include information on parameters for print settings.

In the present embodiment, the timing and method of obtaining the identification and capability information are the same, but they may be different. For example, the auxiliary programs 42 may obtain identification information from the printer 2 and store the same in the memory 12 when searching for devices during installation. As another example, the auxiliary programs 42 may directly obtain either the identification information or the capability information from the selected printer 2.

After obtaining the capability information, the auxiliary programs 42 perform a printer discrimination process (A14). The printer discrimination process is used to determine whether the selected printer is a virtual printer or not based on the identification information contained in the capability information. If, for example, the device identifying information is included in the identification information received from the general-purpose print program 41 at A08, the auxiliary programs 42 determine that the selected printer is a real printer, not a virtual printer 5. On the other hand, the auxiliary programs 42, for example, determine that the selected printer is the virtual printer 5 if the identification information received from the general-purpose print program 41 at A08 does not include device identifying information, or if the identifying information for the virtual printer 5 is included. In addition, the auxiliary programs 42 obtain the registration availability information 46 from the memory 12 (A15).

If the selected printer is the virtual printer 5 and the registration availability information 46 is set to ON (alt: virtual printer and registration availability information ON), the auxiliary programs 42 perform the pass-through registration with the PDF as the registration target (A16). A16 may be an example of a registering process according to aspects of the present disclosure. On the other hand, the auxiliary programs 42 do not perform the pass-through registration if the selected printer is a real printer or if the registration availability information 46 is set to OFF. In other words, the auxiliary programs 42 restrict performing of the pass-through registration. The auxiliary programs 42 may be configured to perform a process to cancel the pass-through registration.

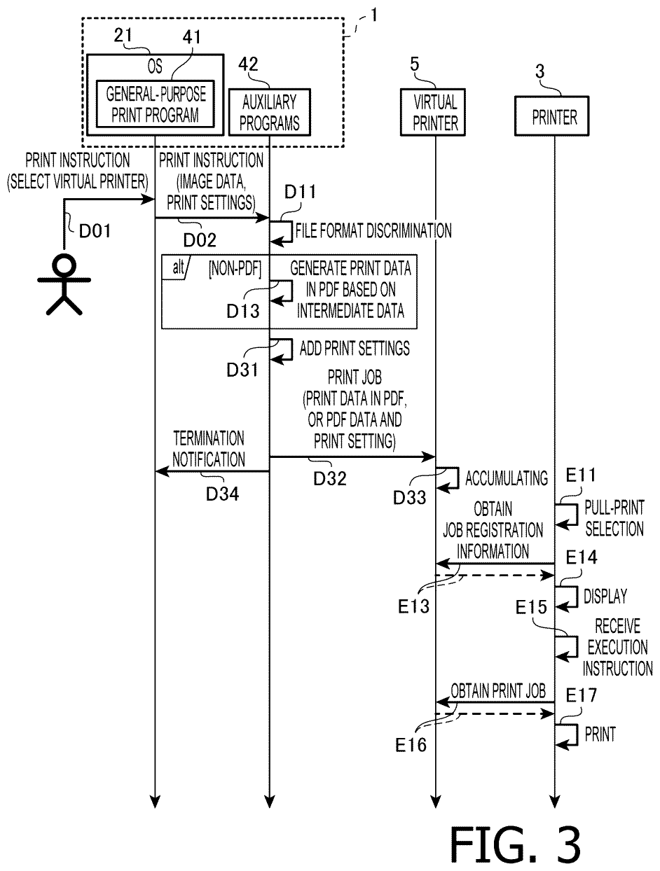

Next, referring to a sequence chart in FIG. 3, procedures by respective programs when an instruction to execute printing is received via the general-purpose print setting screen will be described. The sequence chart shown in FIG. 3 illustrates operations when an instruction to execute printing is received while the virtual printer 5 is selected. It is noted that the instruction by the user to execute printing may be input directly to the general-purpose print program 41, or may be input to an information application 43 and output from the information application 43 to the general-purpose print program 41.

When the general-purpose print program 41 receives an instruction to execute printing by the user via the general-purpose print setting screen in which the virtual printer 5 is selected as the printer to perform printing (DO1), the image data representing the image to be printed and the print settings received via the general-purpose print setting screen are passed to the auxiliary programs 42 (D02). The general-purpose print program 41 handles image data differently depending on the presence or absence of pass-through registration and the file format of the image data to be printed.

If the auxiliary programs 42 perform pass-through registration with the PDF as the registration target at A16 in FIG. 2, and if the file format of the image data to be printed received from the information application 43 at A04 in FIG. 2 is the PDF, the general-purpose print program 41 passes the PDF image data as it is to the auxiliary programs 42.

On the other hand, if the auxiliary programs 42 do not perform the pass-through registration with the PDF as the registration target at A16 in FIG. 2, or if the file format of the image data to be printed is not the PDF data, the general-purpose print program 41 converts the format of the image data representing the image to be printed to the format of the intermediate data. The general-purpose print program 41 passes the generated intermediate data to the auxiliary programs 42 as image data. The image data contained in the information application 43 are of various types, and the general-purpose print program 41 converts the image data to be printed into the intermediate data suitable for generating the print data. The intermediate data is, for example, XPS data.

The pass-through registration is stored in association with the auxiliary programs 42. Therefore, after the pass-through registration by the auxiliary programs 42, if the printer associated with the auxiliary programs 42 is selected, the pass-through registration will become effective. On the other hand, if a printer that is not associated with the auxiliary programs 42 is selected, the pass-through registration will not become effective.

When receiving the image data from the general-purpose print program 41 at D02, the auxiliary programs 42 determine the file format of the received image data (D11). If the discrimination result is that a file format is not the PDF (alt: non-PDF), the auxiliary programs 42 generate print data in the PDF based on the intermediate data received from the general-purpose print program 41 (D13). On the other hand, if the discrimination result is the PDF, the auxiliary programs 42 do not generate print data.

The auxiliary programs 42 add information indicating print settings to the print job containing the PDF image data received at D02 or the PDF print data generated at D13 (D31). The print settings to be added are, for example, the print settings received from the general-purpose print program 41 at D02. The general-purpose print program 41 supports generic print settings but does not support printer-specific print settings. Examples of print settings that the general-purpose print program 41 supports include the number of copies, duplex printing, color printing, feed trays, paper type, paper size, and layout printing (N-in-1 printing).

If the auxiliary programs 42 receive print settings specific to the printer 2 via the detailed setting screen, the auxiliary programs 42 may assign the received print settings to the print job. Examples of the print settings specific to the printer 2 include, for example, watermarking, saving printing, PIN settings, poster printing, booklet printing, and print settings related to post-processing, such as stapling.

The auxiliary programs 42 transmit the print job assigned with the print settings to the selected printer (D32), along with a print command that instructs the printer to execute the print job. The virtual printer 5 that receives the print data and the print command accumulates and stores the print job (D33). The auxiliary programs 42 return a termination notice to the general-purpose print program 41 (D34).

When the printer 3, which is the real printer, receives a pull print function to receive and print a print job from the cloud server 6 (E11), the printer 3 obtains the job registration information from the virtual printer 5 (E13). The job registration information is, for example, a list indicating job names of print jobs accumulated in the virtual printer 5, and does not include print data or print settings. The printer 3 displays the received job registration information (E14). The printer 3 receives a selection of print jobs to be printed from the displayed job registration information, and further, receives instructions to execute printing (E15).

The printer 3 then obtains the selected print job from the virtual printer 5 (E16). For example, the printer 3 requests the virtual printer 5 to transmit the selected print job, and the virtual printer 5 transmits the print job to the printer 3 in response to the request. The printer 3 executes printing based on the print job received from the virtual printer 5 (E17). For example, when a print setting for saving printing is added to the print job, the printer 3 performs printing by controlling the amount of colorant used. For another example, if a print job has been assigned with a print setting that performs stapling, the printer 3 performs a process of stapling the printed sheets with a needle. As a result, a printed material is generated. The printer 3 may perform authority authentication based on PIN information when connecting to the virtual printer 5, when obtaining job registration information, or when obtaining a print job.

In the present embodiment, the printer 3, which is the real printer connected to the virtual printer 5, can support the PDF. Therefore, if the printer 3 receives a print job containing PDF image data at E16, the printer 3 can print the PDF image data as it is without converting the file format. Thus, in the print system 9 according to the present embodiment, when the printer 3 can handle the PDF, the file format of the image data is no longer converted from the PDF to intermediate data, and then to the PDF, thereby avoiding unnecessary processing. Further, the image data of the PDF to be printed is configured such that deterioration in image quality resulting from the conversion of the file format is suppressed. Therefore, the printer 3 can generate good quality printed materials based on the PDF image data.

When the printer 2, which is the real printer, is selected, the pass-through registration is not executed. Therefore, the auxiliary programs 42 receive the intermediate data from the general-purpose print program 41. The auxiliary programs 42 rasterize the received intermediate data to generate the PDL data that can be processed by the printer 2. By rasterizing using the auxiliary programs 42 corresponding to the printer 2, the degree of freedom is greater than a case where the rasterizing using the general-purpose print program 41 is performed, and the print data suitable for printing by the printer 2 can be generated. The print data generated by the auxiliary programs 42 may be in a format that can be used for printing by printers other than the model of the printer 2.

Transmission of the print data and/or print commands to the virtual printer 5 or the printer 2 may be performed by the general-purpose print program 41. That is, the auxiliary programs 42 may pass the generated print data to the general-purpose print program 41 so that the generated print data may be transmitted from the PC 1 to the virtual printer 5 or the printer 2 as the destination. In that case, the general-purpose print program 41 transmits the print data and the like received from the auxiliary programs 42 to the virtual printer 5 or the printer 2.

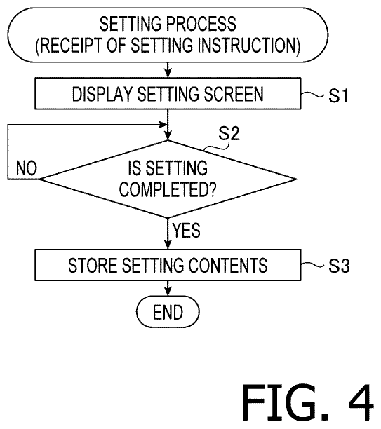

Next, the aforementioned steps of the setting process will be described with reference to a flowchart shown in FIG. 4. It is assumed here that the auxiliary programs 42 corresponding to the printer 2 perform the setting process shown in FIG. 4.

When receiving an instruction to set the pass-through registration in a utility screen provided by, for example, the auxiliary programs 42, the CPU 11 displays the setting screen on the display 13a (S1). The setting screen is a screen for setting whether or not to perform the pass-through registration. The setting screen receives, for example, designation of the file format for pass-through registration, instructions to execute the pass-through registration, instructions to cancel the pass-through registration, and a completion instruction to complete the setting. The setting screen receives the completion instruction by, for example, operation of a completion button.

The CPU 11 determines whether the pass-through registration setting has been completed (S2). If the CPU 11 has not received the completion instruction, the CPU 11 determines that the pass-through registration setting has not been completed (S2: NO) and maintains a status in which the pass-through registration setting can be received.

When receiving the completion instruction (S2: YES), the CPU 11 stores the settings entered on the setting screen in the memory 12 (S3) and terminates the setting process. If, for example, the PDF is specified as the target file format for the pass-through registration and the instruction to execute the pass-through registration is received, the CPU 11 sets the registration availability information 46 to ON. Then, for example, if a target for the pass-through registration is changed from the PDF to another file format on the setting screen, the CPU 11 changes the registration target from the PDF to another file format and updates the registration availability information 46. For example, if an instruction to cancel the pass-through registration is received on the setting screen, the CPU 11 sets the registration availability information 46 to OFF.

Further, for example, there are cases in which the printer 3 cannot print even the registration target is the PDF file. For example, as a result of the pass-through registration, an error may occur when the printer 3 prints a print job containing the PDF image data sent from the information application 43 to the general-purpose print program 41 as it is via the virtual printer 5. In such a case, if an error occurs when printing a print job containing the PDF image data sent from the information application 43 to the general-purpose print program 41 via the virtual printer 5, the error can be avoided by setting the registration availability information 46 to OFF. It is because when OFF is set in the registration availability information 46, the auxiliary programs 42 generate the PDF print data that can be processed by the printer 3 (FIG. 3: D13). It should be noted that if there is only one file format subject to the pass-through registration, it is not necessary to receive the designation of the file format on the setting screen. Further, more than one type of file format may be subject to the pass-through registration.

In the present embodiment, a path of the registration availability information 46 to be stored may be determined in advance by the auxiliary programs 42, or the path of the registration availability information 46 to be stored may be designated, and the designated path may be registered in the auxiliary programs 42. Although the registration availability information 46 is used in the present embodiment, the registration availability information 46 is not mandatory, but the auxiliary programs 42 may operate as if the pass-through registration is always possible.

As described above, when the PC 1 according to the present embodiment receives a print instruction, the intermediate data is usually generated based on the image data to be printed by the general-purpose print program 41, and the generated intermediate data is then passed to the auxiliary programs 42. However, if the pass-through registration is executed to register the PDF as a file format that does not generate intermediate data in the general-purpose print program 41 (A16 in FIG. 2), and the PDF data is the image data to be printed, the image data is passed directly from the general-purpose print program 41 to the auxiliary programs 42 (D02 in FIG. 3). Therefore, the auxiliary programs 42 performs the above pass-through registration when the virtual printer 5 is the destination for transmitting print jobs. In this way, when transmitting a print job to the virtual printer 5, the auxiliary programs 42 that have performed the pass-through registration will transmit the print job containing the PDF image data to the virtual printer 5 (D12 and D32 in FIG. 3). As a result, the printer 3 connected to the virtual printer 5 can import the PDF image data from the virtual printer 5 and print the same. According to this procedure, the image data to be printed is passed to the virtual printer 5 without being converted to the intermediate data, thus eliminating wasteful processing and suppressing image quality degradation.

The auxiliary programs 42 in the present embodiment perform the pass-through registration at a timing before the print instruction is entered, i.e., when the virtual printer 5 is selected (A16 in FIG. 2). In this way, when there is a print instruction to cause the virtual printer 5 to print (D01, D02 of FIG. 3), if the image data to be printed is the PDF image data, the PDF image data will be passed from the general-purpose print program 41 to the auxiliary programs 42 as it is, increasing the possibility that the auxiliary programs 42 will be able to send the image data as the PDF image data to the virtual printer 5.

### Second Embodiment

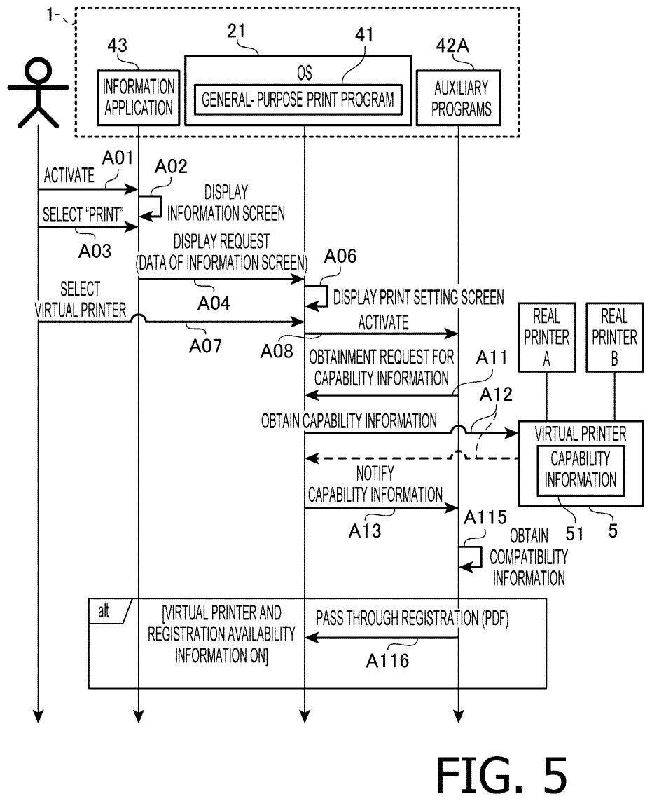

Next, the support program and the print system according to a second embodiment will be described. FIG. 5 is a sequence chart showing an example of the procedure when “Print” is selected. The present embodiment differs from the first embodiment in that the pass-through registration is performed automatically when real printers connected to the virtual printer 5 include a printer that supports the PDF, and the registration availability information 46 is not stored in the memory 12. The following description focuses on points that differ from the first embodiment. The same symbols as in the first embodiment are used for configurations or processes that are common to the first embodiment in the present embodiment, and descriptions are omitted as appropriate.

As shown in FIG. 5, for example, a real printer A and a real printer B are communicatively connected to the virtual printer 5. The virtual printer 5 inquires the newly connected real printer whether the newly connected real printer supports the PDF. The real printer responds to the inquiry whether or not the real printer is a PDF-compliant printer. If, for example, at least one of the real printer A or the real printer B connected to the virtual printer 5 is the PDF-compatible printer, the virtual printer 5 sets ON to the compatibility information 51 stored in an internal memory of the virtual printer 5. On the other hand, if, for example, all the connected real printers are not the PDF-compatible printers, the virtual printer 5 sets OFF in the compatibility information 51 stored in the internal memory. The virtual printer 5 updates the compatibility information 51 each time a new real printer is connected. The number of real printers connected to the virtual printer 5 may be one, three or more.

When receiving a request for processing from the general-purpose print program 41 (A08) with the virtual printer 5 selected (A07), the auxiliary programs 42A obtain capability information from the virtual printer 5 in A11-A13. A11-A13 may be examples of an obtaining process according to aspects of the present disclosure.

When receiving an obtain request for the capability information from the OS 21 at A12, the virtual printer 5 transmits the capability information, including compatibility information 51, to the OS 21.

The auxiliary programs 42A obtain the compatibility information 51 from the capability information of the virtual printer 5 obtained from the general-purpose print program 41 (A115). If the selected printer is the virtual printer 5 and the compatibility information 51 is set to ON (alt: virtual printer and compatibility information ON), the auxiliary programs 42A execute the pass-through registration to the general-purpose print program 41 with the PDF as a registration target (A116). A116 may be an example of a registering process according to aspects of the present disclosure. In contrast, if the selected printer is not the virtual printer 5 but the real printer, or if the compatibility information 51 is set to OFF, the auxiliary programs 42A do not perform the pass-through registration to the general-purpose print program 41, which makes PDFs as the registration target. The process when a print instruction is input with the virtual printer 5 selected is the same as in FIG. 3. It is noted, however, if the image data passed from the general-purpose print program 41 is the intermediate data that is not the PDF data, the print data generated at D13 is the print data in the PDL format.

As described above, if the real printers connected to the virtual printer 5 include a printer that supports the PDF, the auxiliary programs 42A in the present embodiment can import the PDF image data from the virtual printer 5 and print the same. According to the above procedure, the image data to be printed is passed to the virtual printer 5 without being converted to the intermediate data, thus eliminating wasteful processing and suppressing image quality degradation.

It is assumed, for example, that none of the real printers A and B connected to the virtual printer 5 are PDF-compatible. In such a case, even if the auxiliary programs 42A transmit the print data of the image data based on the PDF to the virtual printer 5, the real printers A and B cannot receive such print data from the virtual printer 5 or print the same. However, the auxiliary programs 42A in the present embodiment do not perform the pass-through registration when no real printer that can support the PDF is connected to the virtual printer 5. In this way, for example, if none of the real printers A and B connected to the virtual printer 5 supports the PDF, the PDF image data is prevented from being submitted to the virtual printer 5. Therefore, a situation where the PDF image data submitted to the virtual printer 5 cannot be printed is avoided.

### Third Embodiment

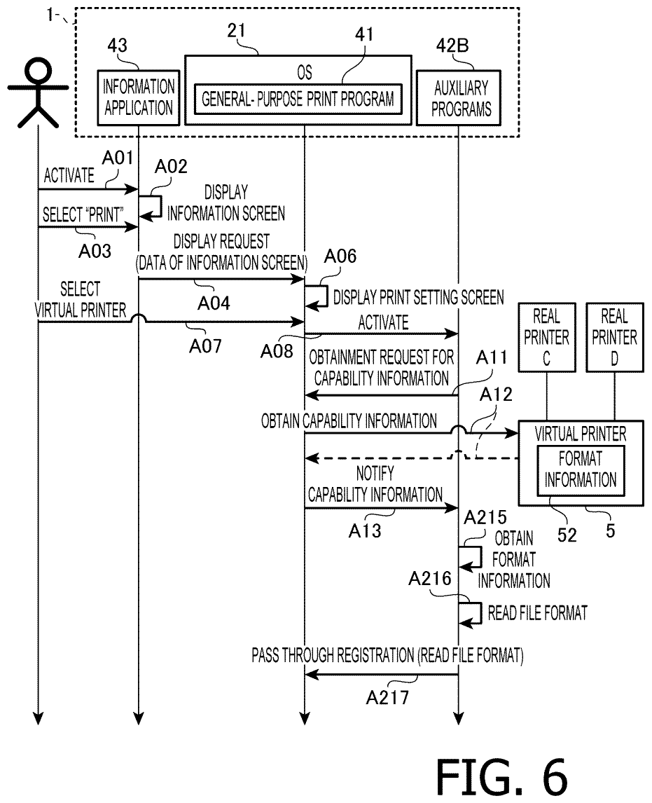

Next, a third embodiment of the support program and print system will be described. FIG. 6 is a sequence chart showing an example of a procedure when “Print” is selected. The present embodiment differs from the first embodiment in that the file formats that can be supported by the real printer connected to the virtual printer 5 are automatically subject to the pass-through registration, while the registration availability information 46 is not stored in the memory 12. The following description focuses on points that differ from the first embodiment. The same symbols as in the first embodiment are used for configurations or processes that are common to the first embodiment in the present embodiment, and descriptions are omitted as appropriate.

As shown in FIG. 6, for example, a real printer C and a real printer D are communicatively connected to the virtual printer 5. The virtual printer 5 inquires the newly connected real printer about the file formats the real printer can support. The real printer responds to the inquiry with the file formats that the real printer supports. The virtual printer 5 stores, for example, the file formats obtained from the connected real printers C and D in the internal memory of the virtual printer as format information 52. For example, if the real printer C is a printer that supports a first file format X1, while the real printer D is a printer that supports a second file format X2, which is different from the first file format X1, the virtual printer 5 stores the format information 52 including the first file format X1 and the second file format X2 in the internal memory thereof. It should be noted that the number of the real printers connected to the virtual printer 5 may be one, three, or more. Further, the real printers connected to the virtual printer 5 may have the same supportable file formats.

When the auxiliary programs 42B is requested by the general-purpose print program 41 for processing (A08) with the virtual printer 5 being selected (A07), the auxiliary programs 42B obtain capability information from the virtual printer 5 in A11-A13. In such a case, when receiving an obtain request for the capability information from the OS 21 at A12, the virtual printer 5 transmits the capability information, including the format information 52, to the OS 21. A11-A13 are examples of an obtaining process.

The auxiliary programs 42B obtains the format information 52 from the capability information of the virtual printer 5 obtained from the general-purpose print program 41 (A215). The auxiliary programs 42B read the file format contained in the format information 52 obtained at A215 (A216). The auxiliary programs 42B execute the pass-through registration to the general-purpose print program 41, using the file format read in A216 as the registration target (A217). In the present embodiment, the pass-through registration is executed with the first file format X1 and the second file format X2 as the registration targets. A217 is an example of a registering process according to aspects of the present disclosure. The process when the print instruction is input with the virtual printer 5 selected is the same as in FIG. 3. It should be noted, however, that if the image data passed from the general-purpose print program 41 is the intermediate data that is non-PDF data, the print data generated in D13 is the print data of the first file format X1 or the second file format X2.

As described above, for example, if the first file format X1, which can be handled by the real printer C, and the second file format X2, which can be handled by the real printer D, are registered in the general-purpose print program 41 as file formats that do not require generation of the intermediate data (A217 in FIG. 6), then, for example, if the data in the first file format X1 is the image data to be printed, the image data is passed from the general-purpose print program 41 to the auxiliary programs 42B without the file format being converted. Therefore, when submitting a print job to the virtual printer 5, the auxiliary programs 42B transmit the print job including the image data of the first file format X1 to the virtual printer 5 (D12 and D32 in FIG. 3). In this way, for example, the real printer C connected to the virtual printer 5 can import the image data of the first file format X1 from the virtual printer 5 and print the same. According to this procedure, the image data to be printed is passed to the virtual printer 5 without being converted to the intermediate data, thus eliminating wasteful processing and suppressing image quality degradation.

The auxiliary programs 42B according to the present embodiment perform the pass-through registration of first file format X1 and the second file format X2 that can be supported by the real printer C and the real printer D that are connected to the virtual printer 5, so that a situation where the image data of the first file format X1 or the second file format X2 that is fed to the virtual printer 5 are not printed can be avoided.

### Fourth Embodiment

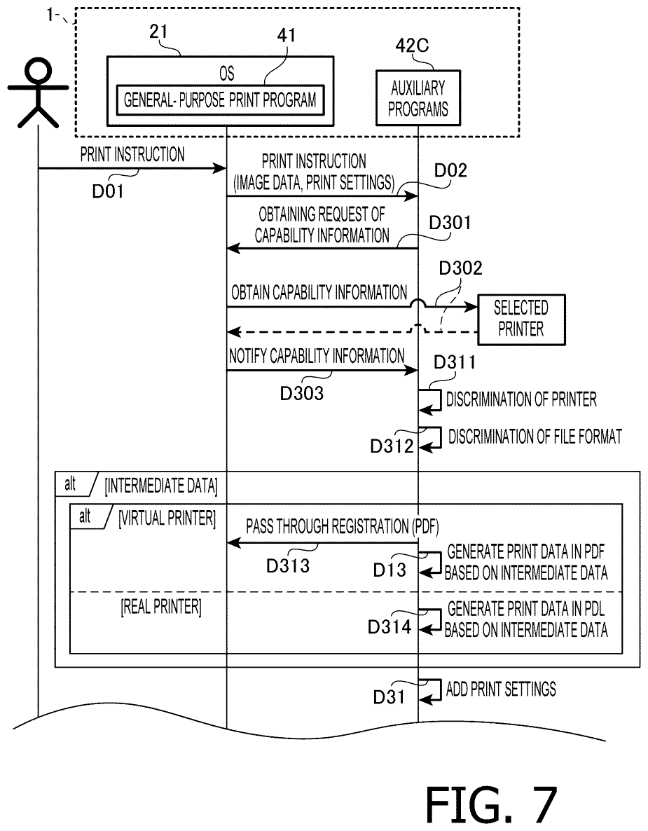

Next, a fourth embodiment of the support program and a print system will be described. FIG. 7 is a sequence chart showing an example of the procedures when a print instruction is received. The present embodiment differs from the first embodiment in that the pass-through is registered at the time of reception of print instructions instead of at the time of the printer selection, and that the processes at A11-A16 shown in FIG. 2 are not performed at the time of the printer selection. The following description focuses on points that differ from the first embodiment. The same symbols as in the first embodiment are used for configurations or processes that are common to the first embodiment in the present embodiment, and descriptions are omitted as appropriate.

When receiving a request for processing from the general-purpose print program 41 by a print instruction, as shown at DO1 and D02 in FIG. 7, the auxiliary programs 42C obtain the capability information from the selected printer (D301 to D303) and determine the printer based on the capability information (D311). D301-D303 and D311 are the processes the same as A11-A14 shown in FIG. 2. The auxiliary programs 42C determine the file format of the image data received from the general-purpose print program 41 (D312).

If the discrimination result at D312 is the file format of the intermediate data (alt: intermediate data) and the discrimination result at D311 is the virtual printer 5 (alt: virtual printer), the auxiliary programs 42C perform the pass-through registration with the PDF as the registration target (D313). D313 may be an example of a registering process according to aspects of the present disclosure. In addition, the auxiliary programs 42C generate print data in the PDF based on the intermediate data (D13). If the discrimination result at D312 is the file format of the intermediate data (alt: intermediate data), but the discrimination result at D311 is the real printer and not the virtual printer 5 (alt: real printer), the auxiliary programs 42C do not perform the pass-through registration and generate print data in the PDL format based on the intermediate data (D314). If the discrimination result at D312 is the PDF, the auxiliary programs 42C will not perform the pass-through registration nor generate the print data. The procedure after D31 is the same as in FIG. 3.

As described above, when the intermediate data is passed while the virtual printer 5 is selected, i.e., not pass-through registration has been performed, the auxiliary programs 42C in the present embodiment performs the pass-through registration with the PDF as the registration target. In this way, if there is a print instruction to print the PDF image data next time with the virtual printer 5 selected, the PDF image data will be passed from the general-purpose print program 41 to the auxiliary programs 42 as it is, and the auxiliary programs 42C will transmit a print job including the PDF data to the virtual printer 5 (D12 and D32 in FIG. 3). Thus, the printer 3 connected to the virtual printer 5 can import PDF image data from the virtual printer 5 and print the same. According to this procedure, the image data to be printed is passed to the virtual printer 5 without being converted to the intermediate data, thus eliminating wasteful processing and suppressing image quality degradation. Further, the general-purpose print program 41 can omit the generation of intermediate data for the PDF from the next print instruction onward.

The auxiliary programs 42C in the present embodiment determines whether or not the pass-through registration has been performed based on whether or not the intermediate data has been received. However, the auxiliary program may be configured to store the fact that the pass-through registration has been performed, or to be able to check from the general-purpose print program 41 whether the pass-through registration has been performed, so that the pass-through registration will be performed on the condition that the pass-through registration has not been performed.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential alternatives, modifications, or variations according to aspects of the present disclosure are provided below.

For instance, the device connected with the PC 1 is not limited to the printer 2 or the printer 3, but may be any device (e.g., multi-function peripheral, copier, and fax machine) having a printing function. The number of real printers connected with the PC 1 and the number real printers connected with the virtual printer 5 are not limited to the example (i.e., one) shown in the relevant drawings, but may be two or more.

It is noted that the pass-through registration may be performed at the time of installation of the auxiliary programs instead of at the time of selection of the printer shown in FIG. 2, FIG. 5, and FIG. 6, or at the time of reception of the print instruction shown in FIG. 7.

Instead of the auxiliary programs 42, another program may perform the setting process shown in FIG. 4. Alternatively, the setting process shown in FIG. 4 may be omitted and the registration availability information 46 may not be stored in the memory 12. In such a case, the auxiliary programs 42 may perform the pass-through registration at A07 in FIG. 2 if the selected printer is the virtual printer 5, and may not perform the pass-through registration if the selected printer is not the virtual printer 5.

It should be noted, however, only the real printer, which do not support the PDF, may be connected to the virtual printer 5. If the setting process shown in FIG. 4 can be executed, the pass-through registration can be set according to the capability of the real printer connected to the virtual printer 5. As a result, a situation in which printing cannot be performed even if the PDF image data is submitted to the virtual printer 5 because the real printer corresponding to the PDF is not connected to the virtual printer 5 can be avoided.

D31 in FIG. 3 may be omitted and no information indicating the print settings may be added to the print job subject to be transmitted. It is noted, however, if the general-purpose print program 41 is configured to transmit information indicating the print settings to the auxiliary programs 42 along with the image data, the auxiliary programs 42 can reflect the printer-specific settings in the printing process.

The cloud server 6 may be a server installed on the Internet 8 by the manufacturer providing the auxiliary programs 42, or a commercial server such as Microsoft OneDrive (registered trademark of Microsoft Corporation) or DropBox (registered trademark of Dropbox, Inc.). The memory 12 may be configured to store registration availability information only when the setting process is configured to perform the pass-through registration, instead of the registration availability information 46.

In the aforementioned embodiment, only the printing operation has been described in detail as the operation by the auxiliary programs 42. However, the auxiliary programs 42 may further have other roles. Examples of the program to perform the processing in the aforementioned embodiment are not limited to the auxiliary programs 42, but may include any program configured to accept instructions from the OS 21 or the general-purpose print program 41 when printing is performed using the general-purpose print program 41. For instance, a print workflow application (Print workflow) whose specifications have been published by Microsoft Corp. may be included in the examples of the program to perform the processing in the aforementioned embodiment.

Practicable examples of the execution timing for executing the auxiliary programs 42 are not limited to the example in the aforementioned embodiment. For instance, the auxiliary programs 42 may be executed in response to a direct execution instruction from the OS 21. In another instance, the auxiliary programs 42 may be resident programs. In this case, the auxiliary programs 42 may perform the aforementioned operations in response to receiving execution commands.

In any flowchart disclosed in the aforementioned embodiment, a plurality of processes in a plurality of any steps may be arbitrarily changed in the execution order thereof or may be executed in parallel as long as there is no inconsistency in the processing results.

The processing disclosed in the aforementioned embodiment may be performed by one or more CPUs, one or more hardware elements such as ASICs, or a combination of at least two selected therefrom. The processing disclosed in the aforementioned embodiment may be implemented in various aspects such as a non-transitory computer-readable storage medium storing computer-readable instructions (e.g., programs) for performing the processing, or a method for performing the processing.

What is claimed is:

1. A non-transitory computer-readable recording medium containing computer-executable instructions that are executable by a computer of an information processing device and compatible with a printing device connected with the information processing device, the computer-executable instructions realizing a support program supporting a general-purpose print program incorporated in advance in an operating system of the information processing device, the information processing device being configured to connect to a virtual printing device provided to a server on a network, the server being configured to receive a print job transmitted to the virtual printing device and store the received print job, the server being configured to transmit the stored print job to a printing device based on a request from the printing device connected to the server, the support program being configured to, when executed by the computer, cause the information processing device to perform:
registering a particular file format as a file format that does not generate intermediate data in the general-purpose print program in a case where a print job is to be transmitted to the virtual printing device;
wherein in a case where execution of a process is required from the general-purpose print program in response to a print instruction which instructs the general-use print program to cause the virtual printing device to print an image and is output by an application program implemented in the information processing device, the support program is configured to, when executed by the computer, cause the information processing device to perform:
when the intermediate data is passed from the general-purpose print program, generating print data based on the passed intermediate data and transmitting a print job including the generated print data to the virtual printing device; and
when image data in the particular file format is passed from the general-purpose print program, transmitting a print job including the passed image data to the virtual printing device.

2. The non-transitory computer-readable recording medium according to claim 1,
wherein PDF is the particular file format, and the PDF is registered as a file format that does not generate intermediate data in the general-purpose print program in the registering.

3. The non-transitory computer-readable recording medium according to claim 1,
wherein the support program is configured to, when executed by the computer, cause the information processing device to perform the registering in a case where execution of a process is required from the general-purpose print program in response to the virtual printing device being selected.

4. The non-transitory computer-readable recording medium according to claim 1,
wherein in a case where execution of a process is required from the general-purpose print program in response to the print instruction which instructs the general-use print program to cause the virtual printing device to print an image and is output by the application program implemented in the information processing device, the support program is configured to, when executed by the computer, cause the information processing device to perform the registering.

5. The non-transitory computer-readable recording medium according to claim 1,
wherein the support program is configured to, when executed by the computer, cause the information processing device to perform:
setting whether to perform the registering; and
restricting performing of the registering in a case where the registering is not set to perform in the setting.

6. The non-transitory computer-readable recording medium according to claim 1,
wherein the support program is configured to, when executed by the computer, cause the information processing device to perform:
transmitting an obtaining request of capability information indicating capability of the virtual printing device to the virtual printing device, the virtual printing device being configured to transmit, to the information processing device, the capability information with including compatibility information indicating that the virtual printing device is compatible with the particular file format in response to the obtaining request of the capability information from the information processing device in a case where there is a printing device compatible with the particular file format among the printing device connected with the information processing device, the virtual printing device being configured to transmit, to the information processing device, the capability information without including compatibility information in response to the obtaining request of the capability information from the information processing device, in a case where there is not a printing device compatible with the particular file format among the printing device connected with the information processing device;
wherein the support program is configured to, when executed by the computer, cause the information processing device to:
perform the registering in a case where the capability information obtained as a response to the obtaining request includes the compatibility information; and
not perform the registering in a case where the capability information obtained as a response to the obtaining request does not include the compatibility information.

7. The non-transitory computer-readable recording medium according to claim 1,
wherein the support program is configured to, when executed by the computer, cause the information processing device to perform:
transmitting an obtaining request of capability information indicating capability of the virtual printing device to the virtual printing device, the virtual printing device being configured to transmit, to the information processing device, the capability information with including format information indicating a file format compatible with a printing device connected to the information processing device in response to the obtaining request of the capability information from the information processing device,
wherein the support program is configured to, when executed by the computer, cause the information processing device to perform:
the registering a file format indicated by the format information included in the capability information obtained as a response to the obtaining request.

8. The non-transitory computer-readable recording medium according to claim 1, wherein, in the transmitting of the print job to the virtual printing device, information indicating print settings is added to the print job subject to be transmitted.
